(19) United States
(12) Patent Application Publication
(10) Pub. No.: US 2007/0222696 A1
(43) Pub. Date: Sep. 27, 2007

(54) Closely Packed Dipole Array Antenna

(75) Inventors: Andreas Wikstrom, Molndal (SE); Jessica Westerberg, Kungalv (SE); Daniel Sjoberg, Borlange (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 11/596,591

(22) PCT Filed: May 18, 2004
(86) PCT No.: PCT/SE04/00774

§ 371 Date: Nov. 15, 2006

(51) Int. Cl. H01Q 21/26

(52) U.S. Cl. 343/797

(57) ABSTRACT

The present invention relates to an antenna device for wireless transmission and reception of information using electromagnetic signals, comprising at least two dipole antenna elements, where each dipole antenna element comprises a first dipole arm and a second dipole arm, which first and second dipole arms are extending in essentially opposite directions from a respective feeding point end. The dipole arms are formed in metal layers on a laminate, having a first side and a second side, which laminate further has a predefined thickness (T) separating the first and second side. Each first dipole arm extend on the first side of the laminate and each second dipole arm extend on the second side of the laminate in such a way that the two adjacent dipole arms of adjacent antenna elements partially overlap during a distance (D).

### TECHNICAL FIELD

The present invention relates to an antenna device for wireless transmission and reception of information using electromagnetic signals, comprising at least two dipole antenna elements, where each dipole antenna element comprises a first dipole arm and a second dipole arm, which first and second dipole arms are extending in essentially opposite directions from a respective feeding point end, where the dipole arms are formed in metal layers on a laminate, having a first side and a second side, which laminate further has a predefined thickness separating the first and second side.

### BACKGROUND ART

The dipole antenna element is a commonly used antenna element, which is applicable in many applications. The dipole antenna element occurs both as a separate antenna and in array antennas, and phased array antennas. The dipole antenna element comprises two conducting metal rods that usually extend in the same plane, in opposite directions from the feeding point, forming two dipole arms. The dipole antenna element further comprises a two-wire conductor, a so-called balanced feed.

The input impedance for a dipole antenna element varies depending on length and diameter of the metal rods, the element is resonant when the length of each rod or dipole arm is approximately λ_{g}/4, i.e. when the total length of the element is approximately λ_{g}/2, where λ_{g} is the effective wavelength in the present material configuration. Further, the rod is preferably placed parallel to a ground plane at an approximate distance of λ_{g}/4. The wavelength in question corresponds to a frequency within the frequency band for which the dipole antenna element is designed.

When several dipole antenna elements are used in, for example, a phased array antenna, an electromagnetic coupling occurs between the elements.

Previously, it has been desirable to minimize the coupling between adjacent antenna elements, but nowadays strong coupling between the dipole arms of adjacent dipole antenna elements can be acceptable, or even desirable. This strong coupling allows current to flow on one dipole as a result of current flow on another in the absence of galvanic contact. Then the current distribution on the total array structure will acquire such properties that a relatively broadband array antenna will be the result, compared to when the coupling between adjacent antenna elements is minimized.

A strong coupling is the effect of small spaces between the dipole antenna elements in the array antenna, and this in turn reduces the occurrences of undesired so-called grating lobes. Grating lobes are undesired radiation pattern lobes that occur when the distance between the antenna elements in an array antenna exceeds λ_{g}/2. As the measure of λ_{g}/2 has its lowest value for the highest frequency, the grating lobes will first occur at the highest frequency in the frequency band for which the dipole antenna element is designed. Therefore, the distance between the antenna elements in an array antenna must fall below λ_{g}/2 at the highest frequency in the frequency band, in order to avoid grating lobes.

The coupling between the adjacent dipole antenna elements may be used to balance the intrinsic inductance of the dipole arms. Intrinsic inductance is also known as the self-inductance of that conductor.

In order to achieve such an advantageous coupling between adjacent dipole arms of adjacent dipole antenna elements, it is important that the coupling distance between the adjacent dipole arms is tuned to an appropriate value. The coupling distance is a very tolerance-sensitive parameter.

In U.S. Pat. No. 6,512,487, a dipole array antenna where the adjacent dipole arms of adjacent dipole antenna elements couple to each other, is disclosed. The dipole antenna elements are etched on a flexible laminate, where the ends of each dipole antenna element is configured for an enhanced coupling to the adjacent dipole antenna element. The enhancement is in the form of interleaved fingers or enlarged portions at the ends.

There is, however, still a problem with the etching tolerances in the embodiments enclosed in U.S. Pat. No. 6,512,487, especially for high frequencies.

The problem with etching tolerances is solved by means of an arrangement according to the book “Finite Antenna Arrays and FSS” written by Ben A. Munk, published 2003, page 185-186, where each dipole antenna element are provided with its dipole arms formed on one side of a laminate. For a certain dipole antenna element, every adjacent dipole antenna element has its dipole arms formed on the opposite side of the laminate, allowing a part of the respective arms to overlap. This overlapping of adjacent dipole arms of adjacent dipole antenna elements allows a controlled coupling to take place.

This configuration has a drawback, since in an array antenna comprising several antenna elements, every second antenna element is formed on a first side of the laminate and every second antenna element is formed a second side of the laminate. This in turn results in that a lattice with twice the periodicity of an ordinary array antenna. As a consequence, the number of radar cross-section (RCS) grating lobes is increased.

### DISCLOSURE OF INVENTION

It is an object of the present invention to provide a dipole array antenna where a controlled electromagnetic coupling between adjacent dipole arms of adjacent dipole antenna elements is achieved and where easy manufacture is allowed, while maintaining a low number of radar cross-section (RCS) grating lobes.

Said object is obtained by means of an antenna device as disclosed in the introduction, where each first dipole arm extend on the first side of the laminate and each second dipole arm extend on the second side of the laminate in such a way that the two adjacent dipole arms of adjacent antenna elements partially overlap during a distance.

Preferred embodiments of the present invention are described in the dependent claims.

Examples of advantages that are obtained by means of the present invention are:
A more robust antenna structure is obtained
A more easily manufactured antenna structure is obtained
Relatively low radar cross-section side lobe levels

### BRIEF DESCRIPTION OF DRAWINGS

The present invention will now be described more in detail with reference to the appended drawings, where

FIG. 1 shows a perspective view of a dipole antenna element;

FIG. 2 shows a side section view of a dipole antenna elements according to the present invention;

FIG. 3 shows an enlargement of a part of FIG. 2;

FIG. 4 shows an enlargement of a part of FIG. 2, in a top view;

FIG. 5 shows a perspective view of a dual polarized dipole antenna element;

FIG. 6 shows a perspective view of a dual polarized dipole antenna array;

FIG. 7 shows a perspective view of two dipole antenna elements according to another embodiment of the present invention;

FIG. 8 schematically shows a perspective view of an array antenna according to the embodiment shown in FIG. 7;

FIG. 9 schematically shows a perspective view of a dual polarized array antenna according to the embodiment shown in FIG. 7;

FIG. 10a shows a first type of dipole antenna element used in the embodiment shown in FIG. 9;

FIG. 10b shows a second type of dipole antenna element used in the embodiment shown in FIG. 9;

FIG. 11 shows a slot detail of the first type of dipole antenna element shown in FIG. 10a;

FIG. 12 shows a variant for the embodiments according to the FIGS. 7-11, where a dielectric material is used;

FIG. 13 shows a variant for the embodiments according to FIG. 9, where a dielectric material is used;

FIG. 14 shows a variant for the embodiments according to FIG. 8, where a dielectric material is used;

FIG. 15 shows a first alternative shape for the dipole arms;

FIG. 16 shows a second alternative shape for the dipole arms; and

FIG. 17 shows a third alternative shape for the dipole arms.

### EMBODIMENTS OF THE INVENTION

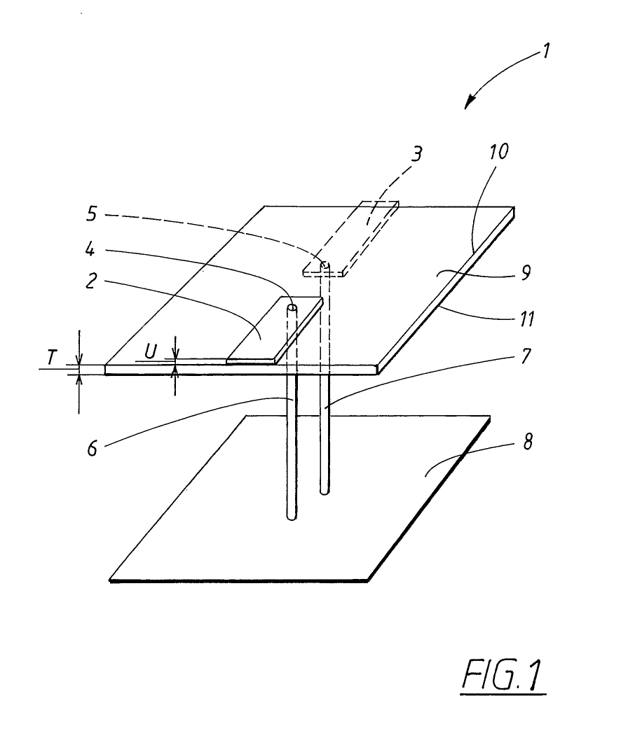

In FIG. 1, a perspective view of a dipole antenna element 1 used in the invention is shown. The dipole antenna element 1 comprises two dipole arms, a first 2 and a second 3 dipole arm, that extend in opposite directions from corresponding feeding point 4, 5 ends. The antenna element 1 comprises feeding conductors 6, 7, for example in the form of coaxial conductors extending through a ground plane 8 below the dipole antenna element 1 and up to the respective feeding point 4, 5.

The dipole arms 2, 3 have a rectangular shape and are, according to the present invention, formed on either side of a supporting laminate 9, preferably by means of etching of metal layers which are adhered to the laminate in question. The etching procedure removes all metallization, for example copper, leaving only the dipole arms. The first dipole arm 2 is formed on a first side 10 of the laminate 9, which first side 10 faces away from the ground plane 8, while the second dipole arm 3 is formed on a second side 11 of the laminate, which second side 11 faces the ground plane 8, where the laminate 9 is substantially parallel to the ground plane 8. The first 10 and second 11 sides of the laminate 9 are essentially planar and substantially parallel to each other, i.e. the laminate 9 has a substantially conformal thickness T.

Further, the etched dipole arms 2, 3 are substantially planar and parallel to the first 10 and second 11 sides of the laminate 9 and extend along these, and thus the feeding conductors 6, 7 extend substantially perpendicular to the laminate sides 10, 11 on which the dipole arms 2, 3 are formed. The dipole arms 2, 3 have a thickness U that equals the thickness of the metallization on the laminate. Usual measures of the metallization thickness U is 17 μm or 35 μm.

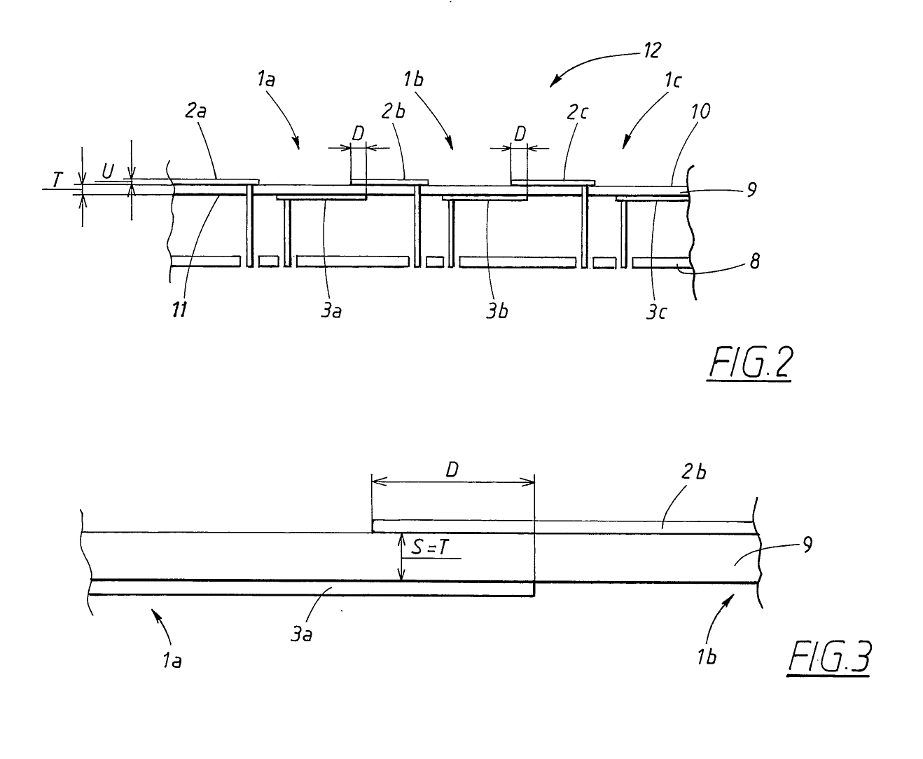

In FIG. 2, a cross-section side view of a part of a linear array antenna 12, comprising antenna elements 1a, 1b, 1c in one dimension only, is shown, each with first and second dipole arms 2a, 3a; 2b, 3b; 2c, 3c. In FIG. 2, a first 1a, second 1b and third 1c dipole antenna element is shown, where, according to the invention, the second dipole arm 3a of the first dipole antenna element 1a extends on the second side 11 of the laminate 9, and where the first dipole arm 2b of the adjacent second dipole antenna element 1b extends on the first side 10 of the laminate 9. The second dipole arm 3a of the first dipole antenna element 1a and the first dipole arm 2b of the adjacent second dipole antenna element 1b extend towards each other in such a way that they pass each other on each side 11, 10 of the laminate 9 over a distance D, forming an overlapping structure along the distance D.

Similarly, the second dipole arm 3b of the second dipole antenna element 1b extends on the second side 11 of the laminate 9, and the first dipole arm 2c of the adjacent third dipole antenna element 1c extends on the first side 10 of the laminate 9. The dipole arms 3b, 2c extend towards each other in such a way that they pass each other on each side 11, 10 of the laminate 9 during a distance D, forming an overlapping structure in the same way as described above.

This overlapping configuration for adjacent dipole antenna arms of adjacent dipole antenna elements, as described for the dipole antenna elements 1a, 1b, 1c shown in FIG. 2, is, where applicable, implemented for all dipole antenna elements in the linear array antenna 12.

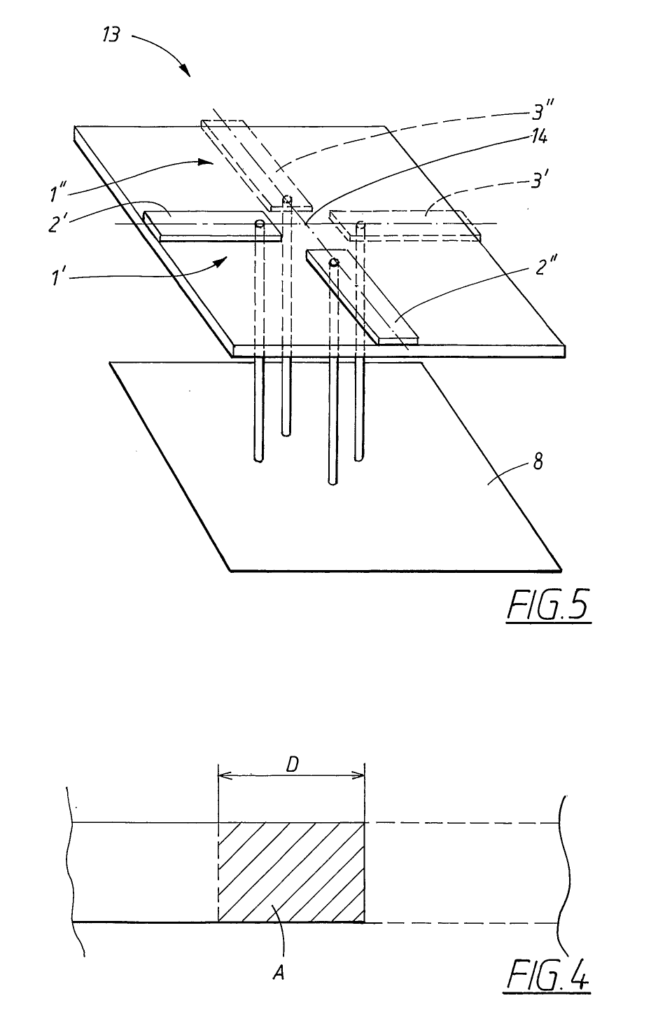

In FIG. 3 and FIG. 4, an enlarged image of a cross-section side view and a top view, respectively, of the overlapping configuration is shown. Along the distance D, at which adjacent dipole antenna arms 3a, 2b of adjacent dipole antenna elements 1a, 1b pass each other at opposite sides of the laminate 9, an electromagnetic coupling occurs between the adjacent dipole antenna arms 3a, 2b.

The electromagnetic coupling, is determined by means of the area A (shown as shaded) of the overlapping parts of the dipole arms and the distance S between the overlapping parts of the dipole arms 3a, 2b, which distance S is equal to the laminate thickness T as it is measured between the first side 10 and the second side 11 of the laminate 9, perpendicular to the sides 10, 11 and the main surfaces of the rectangular dipole arms 3a, 2b.

In order to achieve advantageous coupling effects between adjacent dipole arms 3a, 2b of adjacent dipole antenna elements 1a, 1b, it is important that the coupling distance S between the adjacent dipole arms is tuned to a value corresponding to an appropriate coupling strength. The most sensitive parameter when performing such a tuning is the distance S between the dipole arms. As the distance S equals the laminate thickness T, an advantageous effect is obtained, since the laminate thickness T is very well controlled by the laminate manufacturer, resulting in a conformal thickness T having a stable measure all over the laminate 9, even from laminate sheet to laminate sheet.

It is important that the relative dielectric constant εᵣ of the laminate material in question is stable. εᵣ is very well controlled by the laminate manufacturer, resulting in a conformal εᵣ value having a stable measure all over the laminate 9, even from laminate sheet to laminate sheet.

Therefore, the laminate thickness T is very easy to use for controlling the coupling between the dipole arms in question, as this measure is previously known and controlled by the laminate supplier. It is, however, not possible to tune the coupling distance S=T, once a certain laminate material has been chosen for one's design.

As the thickness T is given when a particular laminate is chosen, the coupling is tuned by means of the area A of the overlapping parts of the dipole arms. This area A is quite easy to control by means of ordinary etching as there are no adjacent etched structures on the same side of the laminate 9 to take into consideration, therefore decreasing the need for high etching tolerances.

Of course, several linear array antennas according to the above may be placed in rows, such that two-dimensional array antennas (not shown) are formed.

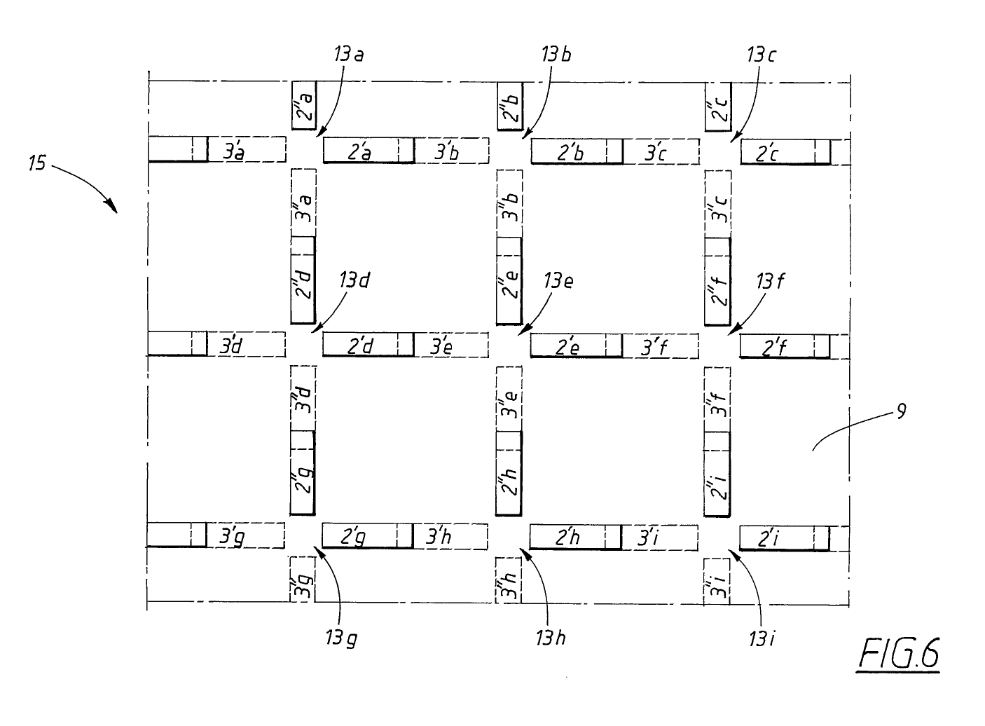

In FIG. 5, a dual-polarized dipole antenna element 13 is shown, consisting of two dipole antenna elements 1′, 1″, similar to the one shown in FIG. 1, that are placed orthogonally around a common centre point 14. This element 13 may be used in a dual polarized one-dimensional or two-dimensional array antenna 15, as shown in FIG. 6. There, the dipole arms 2′a, 3′a, 2″a, 3″a; 2′b, 3′b 2″b, 3″b; 2′c, 3′c, 2″c, 3″c; 2′d, 3′d, 2″d, 3″d; 2′e, 3′e, 2″e, 3″e; 2′f, 3′f, 2″f, 3″f; 2′g, 3′g, 2″g, 3″g; 2′h, 3′h 2″h, 3″h; 2′i, 3′i, 2″i, 3″i of each dual polarized antenna element 13a-13l extend on opposite sides of the laminate 9 in such a way that adjacent dipole arms 2′a, 3′b; 2′b, 3′c; 3″a, 2″d; 3″b, 2″e; 3″c, 2″f; 2′d, 3′e; 2′e, 3′f; 3″d, 2″g; 3″e, 2″h; 3″f, 2″i; 2′g; 3′h; 2′h, 3′i of adjacent antenna elements 13a, 13b; 13b, 13c; 13a, 13d; 13b, 13e; 13c, 13f; 13d, 13e; 13e, 13f; 13d, 13g; 13e, 13h; 13f, 131; 13g, 13h; 13h, 131 partially overlap, as they extend on opposite sides of the laminate 9 as described above. Thus, the coupling between adjacent dipole antenna elements 13a, 13b; 13b, 13c; 13a, 13d; 13b, 13e; 13c, 13f; 13d, 13e; 13e, 13f; 13d, 13g; 13e, 13h; 13f, 131; 13g, 13h; 13h, 131 described above is obtained in this case as well, which coupling provides all the advantageous features described previously.

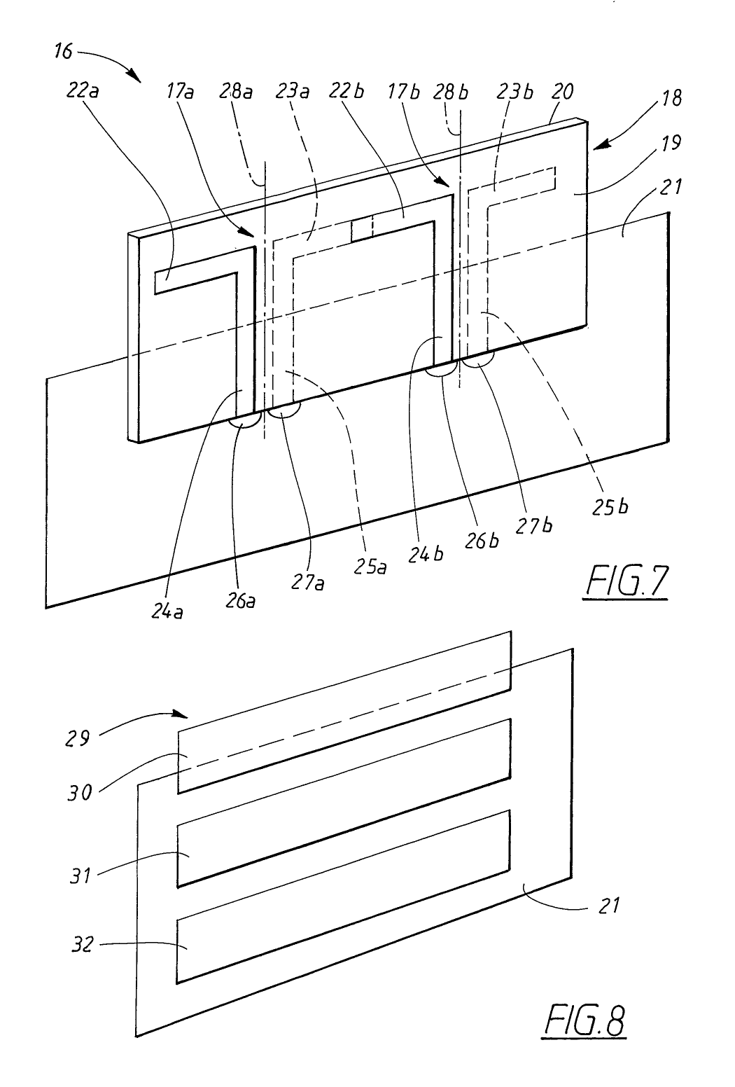

In FIG. 7, another preferred embodiment of the present invention is shown. There, an array antenna 16 is shown, having a first 17a and a second dipole antenna element 17b, formed on a laminate 18, having a first side 19 and a second side 20, which laminate 18 positioned perpendicular to a ground plane 21. The dipole antenna elements 17a, 17b have two dipole arms 22a, 23a; 22b, 23b each. The first dipole arms 22a, 22b of the first and second dipole antenna element 17a, 17b are etched on the first side 19 of the laminate 18, and the second dipole arms 23a, 23b of the first and second dipole antenna element 17a, 17b are etched on the second side 20 of the laminate 18.

The second dipole arm 23a of the first dipole element 17a is adjacent to the first dipole arm 22b of the second dipole element 17b, and the adjacent dipole arms 23a, 22b of the adjacent dipole antenna elements 17a, 17b extend towards each other in such a way that they pass each other on each side 19, 20 of the laminate 18 over a distance D, forming an overlapping structure along the distance D.

The feeding conductors 24a, 25a; 24b, 25b are a part of the etched structure, leading directly from connectors (not shown) formed in openings 26a, 27a; 26b, 27b in the ground plane 21, at the bottom of the laminate, to the respective dipole arm 22a, 23a; 22b, 23b at the top of the laminate. The feeding conductors 24a, 25a; 24b, 25b have an abrupt essentially perpendicular transition to the respective dipole arm 22a, 23a; 22b, 23b. The feeding conductors 24a, 25a; 24b, 25b may also have a curved, smooth perpendicular transition to the respective dipole arm 22a, 23a; 22b, 23b (not shown). Each dipole antenna element 17a, 17b is divided into two parts by a symmetry line 28a, 28b, and the main surface of the dipole arms 22a, 23a; 22b, 23b extend substantially perpendicular to the ground plane 21.

A laminate according to FIG. 7 may comprise only one dipole antenna element, but preferably comprises a row of at least two dipole antenna elements, i.e. a one-dimensional array antenna. In the example described, the array antenna 16 comprises two dipole antenna elements 17a, 17b. The coupling between adjacent dipole antenna elements described above is obtained in this case as well in the same way as described above, which coupling provides all the advantageous features described previously.

A two-dimensional array antenna 29, as shown very schematically, without indicating any antenna elements, in FIG. 8, may be formed by placing several linear array antenna laminates 30, 31, 32 according to the above in equidistant rows.

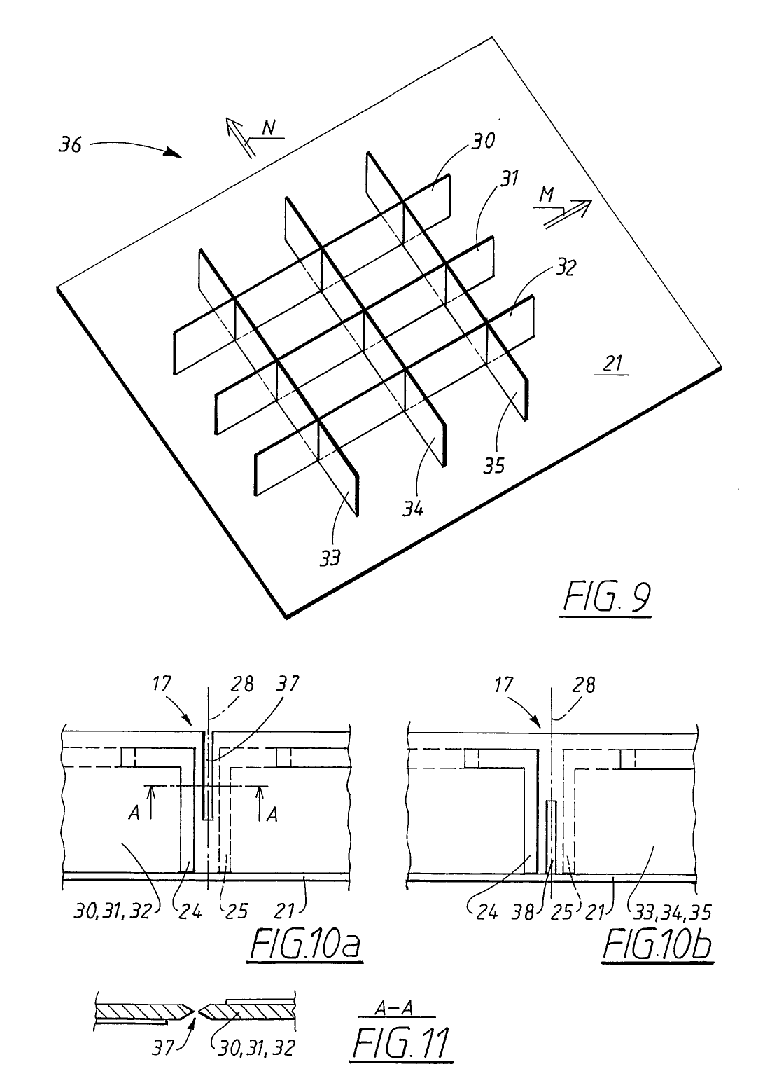

Such a two-dimensional array antenna 29 having antenna laminates 30, 31, 32 placed in rows may be supplied with orthogonally placed antenna laminates 33, 34, 35, as shown very schematically, without indicating any antenna elements, in FIG. 9, thus creating a dual polarized array antenna 36.

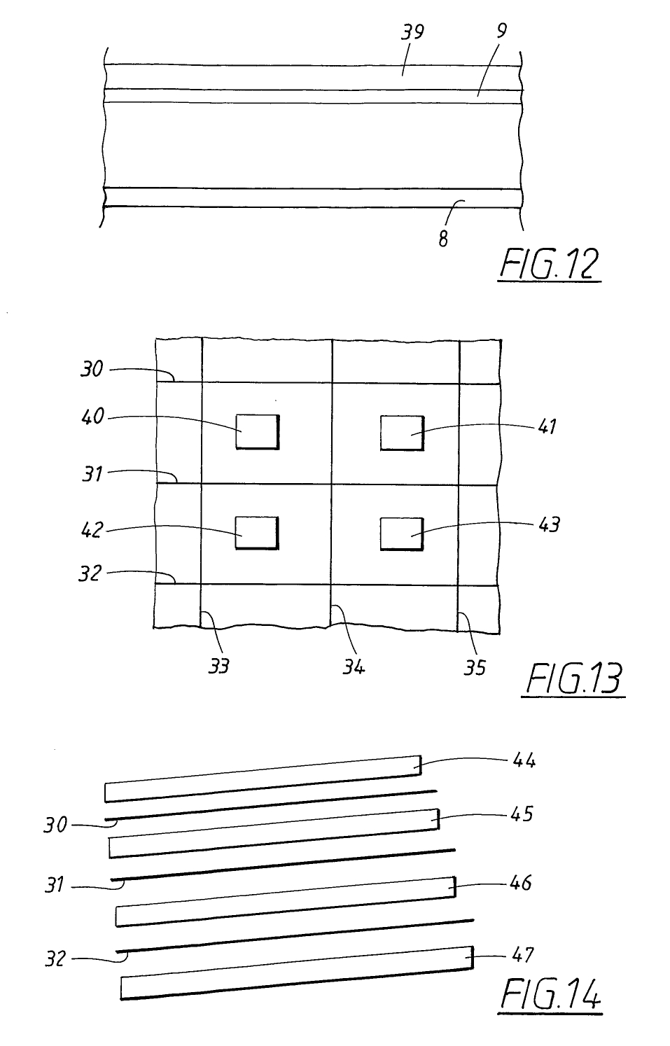

In order to achieve this, with reference also to FIG. 10a and FIG. 10b, the antenna laminates 30, 31, 32 extending in a first direction, indicated with the arrow M, have slots 37 extending from the top of the laminate 30, 31, 32, to a little more than halfway towards the ground plane 21. The antenna laminates 33, 34, 35 extending in a second direction, indicated with the arrow N, orthogonal to the first direction M, have slots 38 extending from the bottom, from the ground plane 21, a little more than halfway towards the dipole arms. The slots 37, 38 are positioned between the feeding conductors 24, 25 and the dipole arm 22, 23 of each dipole antenna element 17, i.e. in the symmetry line 28 of each dipole antenna element 17.

In order to put together the array antenna 36 according to FIG. 9, the antenna laminates 30, 31, 32 extending in the first direction M are positioned on the ground plane 21, in such a way that its feeding conductors 24, 25 are connected to the respective conductors (not shown). Then the slots 38 of the antenna laminates 33, 34, 35 extending in the second direction N are thread on to the slots 37 of the antenna laminates 30, 31, 32 extending in the first direction M in such a way that its feeding conductors 24, 25 are connected to the respective conductors (not shown). The orthogonal laminates 30, 31, 32; 33, 34, 35 are then in place, forming a grid with dual polarized dipole antenna elements.

The slots 37, 38 are preferably made by means of conical milling from each side, providing the slots with a self-aligning structure, as shown for slot 37 of the antenna laminates 30, 31, 32 extending in the first direction M in FIG. 11. FIG. 11 is a section of a part of FIG. 10a.

In a preferred embodiment with reference to FIG. 12, a first dielectric material layer 39 is inserted on the first side 10 of the laminate 9. The insertion of such a dielectric material causes the current distribution on the total array structure to acquire properties resulting in an even more broadband array antenna. The insertion of such a material according to the above is applicable for the previous embodiments disclosed with reference to FIG. 1-6. FIG. 12 is a simplified view, showing no dipole antenna elements, only the relative position of the laminate 9, the ground plane 8 and the dielectric material layer 39. It is also possible to insert a second dielectric material layer between the laminate 9 and the ground plane 8 (not shown) with or without the previously disclosed first dielectric material layer 39.

The dielectric material layers disclosed above may also consist of separate parasitic elements in the form of dielectric material pieces placed in such a way that the pieces are not placed above or beneath any metal part of the antenna elements (not shown).

In another preferred embodiment with reference to FIG. 13, parasitic elements in the form of dielectric material pieces 40, 41, 42, 43 are arranged symmetrically in spaces that occur between the orthogonally placed laminates 30, 31, 32; 33, 34, 35. The advantages obtained are similar to those discussed above with reference to FIG. 12. This embodiment applies for the variants disclosed with reference to FIG. 7-11 i.e. it is also applicable for linear polarized array antennas 16, 29 as shown in FIG. 7 and FIG. 8. For the case with said linear polarized array antennas 16, 29, the parasitic elements are placed at each side of a row, as shown in FIG. 14, where parasitic elements 44, 45, 46, 47 are placed at each side of a row 30, 31, 32.

FIG. 13 is a simplified top view of a grid structure as shown in FIG. 9, FIG. 14 is a simplified top view of a structure as shown in FIG. 8.

The invention is not limited to the described embodiment examples disclosed above, but may vary within the scope of the appended claims. For example, the dielectric materials disclosed above may also comprise several stacked dielectric material layers with similar or different dielectric properties.

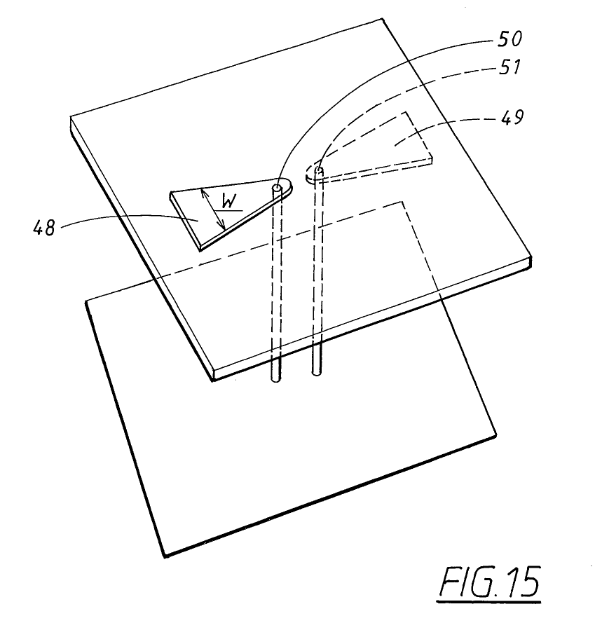

The shape of the dipole element arms is shown rectangular, but may have other shapes. A preferred shape is a triangular shape, as shown in FIG. 15, were the width w of each dipole arm 48, 49 is smallest at the feeding point 50, 51 end, and increases towards the other end of the respective arm 48, 49.

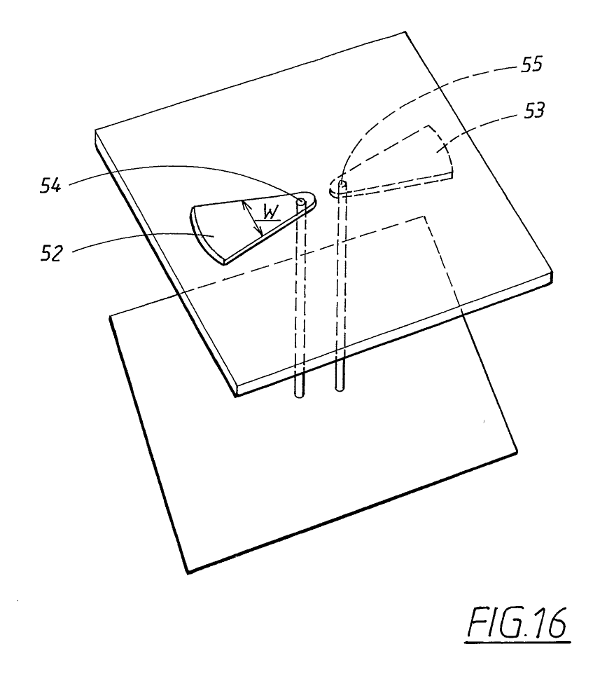

A variant of the triangular shape is the sectorial shape, where the dipole arms constitute sectors of a circle, as shown in FIG. 16. Here the width w of each dipole arm 52, 53 is smallest at the feeding point 54, 55 end, and increases towards the other end of the respective arm 52, 53, at which other end the sectorial shape is apparent.

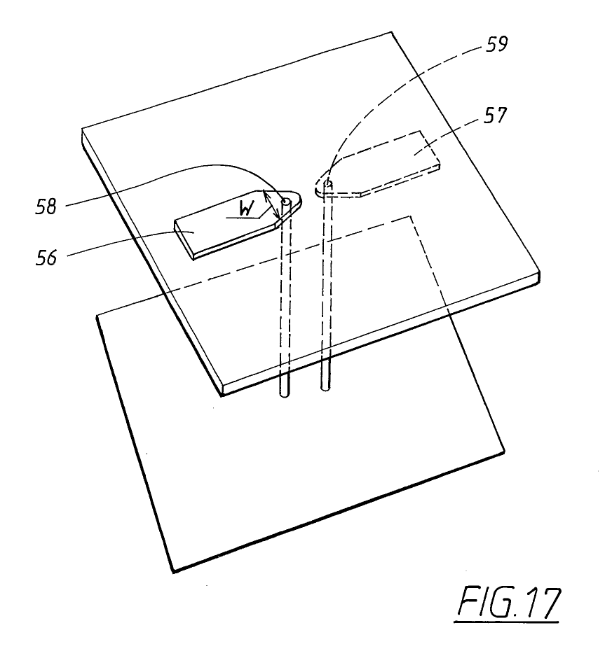

With reference to FIG. 17, the width w of each dipole arm 56, 57 is smallest at the feeding point 58, 59 end, and increases towards the other end of the respective arm 56, 57, but reaches its maximum before reaching the edge of each dipole arm 56, 57.

The advantages with these shapes described with reference to FIG. 15-17 is that the impedance of the feeding line does not have to transfer to another impedance abruptly, but smoothly. These shapes of the dipole arms applies for all the embodiments disclosed in the description.

The dipole antenna elements are suitable for use in large array antennas, such as phased array antennas.

1. An antenna device for wireless transmission and reception of information using electromagnetic signals, comprising at least two dipole antenna elements, where each dipole antenna element comprises a first dipole arm and a second dipole arm, which first and second dipole arms are extending in essentially opposite directions from a respective feeding point end, where the dipole arms are formed in metal layers on a laminate, having a first side and a second side, which laminate further has a predefined thickness separating the first and second side, characterized in that each first dipole arm extend on the first side of the laminate and each second dipole arm extend on the second side of the laminate in such a way that the two adjacent dipole arms of adjacent antenna elements partially overlap during a distance.

2. Antenna device according to claim 1, characterized in that the first side of the laminate faces away from a ground plane, while the second side of the laminate faces the ground plane, where the laminate is substantially parallel to the ground plane.

3. Antenna device according to claim 1, characterized in that each dipole antenna element is provided with a symmetrically arranged orthogonal dipole antenna element, each of these said antenna elements having a common centre point, and each pair of orthogonally arranged dipole antenna elements forming a dual polarized antenna element.

4. Antenna device according to any one of the preceding claim 1, characterized in that a first dielectric material layer is inserted on the first side of the laminate.

5. Antenna device according to claim 2, characterized in that a second dielectric material layer is inserted between the laminate and the ground plane.

6. Antenna device according to claim 4, characterized in that the dielectric material layers in turn comprise several stacked dielectric material layers with similar or different dielectric properties.

7. Antenna device according to claim 1, characterized in that the laminate, is positioned perpendicular to a ground plane.

8. Antenna device according to claim 7, characterized in that feeding conductors are formed on the respective side of the laminate, leading directly from connectors formed in openings in the ground plane, to the respective dipole arm, in such a way that each dipole antenna element is divided into two parts by a symmetry line.

9. Antenna device according to claim 7, characterized in that at least two laminates are positioned in equidistant rows, forming a two-dimensional array antenna.

10. Antenna device according to claim 7, characterized in that at least two laminates are positioned in equidistant rows and at least two laminates are orthogonally positioned in equidistant rows, forming a two-dimensional dual polarized array antenna, where the intersections between the orthogonally positioned laminates essentially takes place in the middle of each dipole antenna element by means of corresponding slots.

11. Antenna device according to claim 9, characterized in that a dielectric material is inserted between each laminate.

12. Antenna device according to claim 1, characterized in that each dipole arm has a rectangular shape.

13. Antenna device according to claim 1, characterized in that each dipole arm has a triangular shape, were the width (w) of each dipole arm is smallest at the feeding point end, and increases towards the other end of the respective arm.

14. Antenna device according to claim 1, characterized in that each dipole arm has a sectorial shape, where the dipole arms constitute sectors of a circle and the width (w) of each dipole arm is smallest at the feeding point end, and increases towards the other end of the respective arm.

15. Antenna device according to claim 1, characterized in that the width (w) of each dipole arm is smallest at the feeding point end, and increases towards the other end of the respective arm, but reaches its maximum before reaching said other edge of each dipole arm.
